(19) United States
(12) Patent Application Publication
(10) Pub. No.: US 2018/0101389 A1
(43) Pub. Date: Apr. 12, 2018

(54) BOOT DETECTION SYSTEM AND BOOT DETECTION METHOD FOR COMPUTER

(71) Applicants: Inventec (Pudong) Technology Corporation, Shanghai (CN); INVENTEC CORPORATION, TAIPEI CITY (TW)

(72) Inventor: Chao-Yang CHENG, TAIPEI CITY (TW)

(21) Appl. No.: 15/466,854

(22) Filed: Mar. 22, 2017

(30) Foreign Application Priority Data
Oct. 11, 2016 (CN) 201610885266.8

(51) Int. Cl. G06F 9/44

(52) U.S. Cl. CPC G06F 9/4406; G06F 9/4403

(57) ABSTRACT

A boot detection system and a boot detection method for a computer are disclosed herein, in which the boot detection system includes a management controller and a basic input/output system (BIOS). The BIOS is electrically coupled to the management controller. The management controller is configured to set a flag value according to a boot type of the computer and record the flag value. The BIOS is configured to detect the flag value and send an event generating command to the management controller according to the flag value in order to control to the management controller to generate a boot event. The boot event is a power up event or a warm reset event.

### RELATED APPLICATIONS

This application claims priority to Chinese Application Serial Number 201610885266.8, filed Oct. 11, 2016, which is herein incorporated by reference.

### BACKGROUND

### Technical Field

The present invention relates to a detection technology. More particularly, the present invention relates to a boot detection system and a boot detection method for computer.

### Description of Related Art

There are many methods for turning on a computer, for example, a power button, a chassis command, a button combination of ctrl, aft and del, a restart button, which can turn on or restart the computer. However, a present computer can merely record whether the system has been through a boot process, but cannot identify whether a boot type is power up (i.e., a DC power supply in the system is turned off and then turned on) or warm reset (i.e., the DC power supply in the system keeps on). If the power is turned on too frequently, damage on the hardware of the computer may be caused. Warm reset is less possible to cause the problem, and therefore information of the boot type is important to a system administrator. However, if the system administrator cannot be near to the computer at all times, then the system administrator is unable to know which boot type the last boot of the computer is.

### SUMMARY

In order to provide a detailed information of computer boot to a user, an aspect of the present disclosure is a boot detection system for computer, which includes a management controller and a basic input/output system (BIOS). The BIOS is electrically coupled to the management controller. The management controller is configured to set a flag value according to a boot type of the computer and record the flag value in the management controller. The BIOS is configured to detect the flag value in the management controller, send an event generating command to the management controller according to the flag value to control the management controller to generate a boot event, and store the boot event in the management controller. The boot event is a power up event or a warm reset event.

Another aspect of the present disclosure is a boot detection method for computer. The boot detection method includes steps as follows. A flag value is set according to a boot type of the computer and recorded in the management controller by a management controller. The flag value in the management controller is detected by a BIOS. An event generating command is sent to the management controller according to the flag value by the BIOS. A boot event is generated and stored in the management controller by the management controller. The boot event is a power up event or a warm reset event.

Through the above embodiments, the present disclosure can identify whether the boot type of the computer is power up or warm reset by the boot event, that is, whether the DC power supply of the computer is turned off (e.g., power failure) and then turned on. Compared to the prior art that can merely identify whether the computer restarts, the present disclosure can further identify whether the boot type of the computer is power up or warm reset to provide more detailed information to the user, and resolve the problem of incapability of precisely determining the boot type in a recent Internet of things (IoT) system so as to help the administrator and the user to understand machine condition at any time.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a schematic diagram of a boot detection system for computer according to an embodiment of the present disclosure;

FIG. 2 is a flow chart of a boot detection method for computer according to an embodiment of the present disclosure;

FIG. 3 is a flow chart of a boot detection method for computer according to an embodiment of the present disclosure;

FIG. 4 is a flow chart of a boot detection method for computer according to an embodiment of the present disclosure; and

FIG. 5 is a flow chart of a boot detection method for computer according to an embodiment of the present disclosure.

### DETAILED DESCRIPTION

In order to make the description of the disclosure more detailed and comprehensive, reference will now be made in detail to the accompanying drawings and the following embodiments. However, the provided embodiments are not used to limit the ranges covered by the present disclosure; orders of step description are not used to limit the execution sequence either. Any devices with equivalent effect through rearrangement are also covered by the present disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, or “includes” and/or “including” or “has” and/or “having” when used in this specification, specify the presence of stated features, regions, integers, steps, operations, elements, and/or components, but do not preclude the presence or addition of one or more other features, regions, integers, steps, operations, elements, components, and/or groups thereof.

In this document, the term “coupled” may also be termed as “electrically coupled”, and the term “connected” may be termed as “electrically connected,” “coupled” and “connected” may also be used to indicate that two or more elements cooperate or interact with each other.

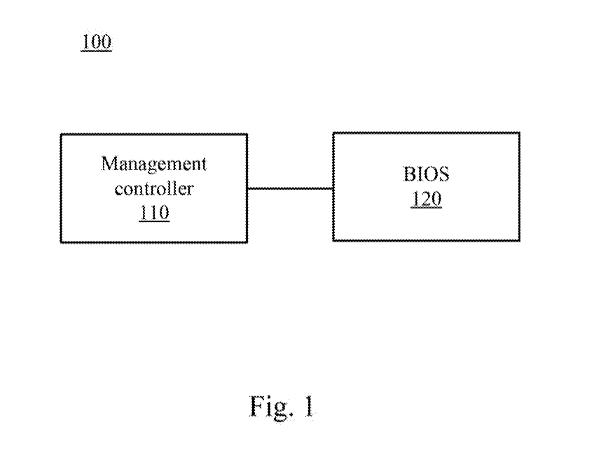

FIG. 1 is a schematic diagram of a boot detection system 100 for computer according to an embodiment of the present disclosure. The boot detection system 100 includes a management controller 110 and a basic input/output system (BIOS) 120, in which the BIOS 120 is electrically coupled to the management controller 110. The management controller 110 is configured to set a flag value according to a boot type of the computer, and record the flag value in the management controller 110. It should be describe that the management controller 110 may include a sensor (e.g., a logical sensor) to detect the boot type. Therefore, the management controller 110 can set the flag value according to the detected boot type. The BIOS 120 is configured to detect the flag value (e.g., 1 or 0, which may be defined by an administrator system according to actual demand) in the management controller 110, and send an event generating command to the management controller 110 according to the flag value to control the management controller 110 to generate a boot event (e.g., a power up event, a warm reset event) and store the boot event in the management controller 110. The boot event may be a power up event or a warm reset event.

For example, the power up event is a boot event where a DC power supply in the computer is turned off and then turned on (e.g., power failure, a situation where a power button is pressed to turn off the computer, however the present disclosure is not limited thereto), and the warm reset event is a boot event where the DC power supply in the computer keeps on (e.g., a warm reset command, a situation where a reset button is pressed, however, the present disclosure is not limited thereto).

As a result, a user can know that the boot type of the computer is the power up event or the warm reset event through the boot event generated by the boot detection system 100, that is, the user can know whether the DC power supply is turned off (e.g., power failure) and then turned on. Compared to the prior art that can merely identify whether the computer restarts, the boot detection system 100 of the present disclosure can further identify that the boot type of the computer is power up or reset to provide more detailed information to the user.

In a specific embodiment, when the computer initializes (i.e., an AC power supply in the computer is turned on from an off state), the management controller 110 initializes and sets the flag value as a first value (e.g., 1). When the DC power supply in the computer is turned on from an off state (i.e., the computer turns on), the BIOS system 120 sends a flag value detecting command to the management controller 110 to detect the flag value. The management controller 110 responses the flag value detecting command and sends the flag value to the BIOS system 120. When the BIOS system 120 detects that the flag value is the first value (e.g., 1), the BIOS system 120 sends a flag value setting command to the management controller 110 for controlling the management controller 110 to set the flag value as a second value (e.g., 0). The BIOS system 120 sends the event generating command to the management controller 110 for controlling the management controller 110 to generate the power up event according to the detected flag value (i.e., the first value).

In another specific embodiment, in a situation where the DC power supply in the computer is turned off and then turned on, because the computer has already been through the initialization process, the management controller 110 that receives the flag value setting command sets the flag value as the second value (e.g., 0). When the management controller 110 detects that the DC power supply is turned off (e.g., by detecting that an advanced configuration and power interface (ACPI) is power-off), the management controller 110 sets that the flag value as the first value (e.g., 1). When the DC power supply in the computer is turned on (i.e., the computer is turned on), the BIOS system 120 sends the flag value detecting command to the management controller 110 to detect the flag value. The management controller 110 responses the flag value detecting command and send the flag value to the BIOS system 120. When the BIOS system 120 detects that the flag value is the first value, the BIOS system 120 sends the flag value setting command to the management controller 110 for controlling the management controller 110 to set the flag value as the second value. The BIOS system 120 sends the event generating command to the management controller 110 for controlling the management controller 110 to generate the power up event according to the detected flag value (i.e., the first value).

In another specific embodiment, in a situation where the DC power supply in the computer remains a turn-on state and the computer restarts, as aforementioned, because the computer has already been through the initialization process, the flag value is the second value (e.g., 0). When the management controller 110 doesn't detect that the DC power supply is turned off (e.g., not detecting that the ACPI is power-off), the flag value is kept as the second value. When the DC power supply in the computer is turned on (i.e., the computer is turned on), the BIOS system 120 sends the flag value detecting command to the management controller 110 to detect the flag value. The management controller 110 responses the flag value detecting command and sends the flag value to the BIOS system 120. When the BIOS system 120 detects that the flag value is the second value, the BIOS system 120 doesn't send the flag value setting command to the management controller 110, that is, keeps the flag value as the second value. The BIOS system 120 sends the event generating command to the management controller 110 for controlling the management controller 110 to generate the warm reset event according to the detected flag value (i.e., the second value).

In an embodiment, the management controller 110 may record the boot event (including the power up event and the warm reset event) in a log file. Therefore, the user can know that the boot type of the computer is power up or warm reset by directly reading contents of the log file.

In practice, the management controller 110 may be a baseboard management controller (BMC). The BIOS system 120 executes actions of the sent commands through a firmware.

The flag value detecting command, the flag value setting command and the event generating command may be implemented as intelligent platform management interface (IPMI) commands. The IPMI commands may be standard IPMI commands or user-defined IPMI commands (e.g., original equipment manufacturer (OEM) IPMI commands). For example, the event generating command may be a sensor reading command of the standard IMPI commands to read the logic sensor in the management controller 110, and generate the power up event or the warm reset event accordingly.

It should be supplemented that, in application of a server environment, when the server restarts, the administrator can conveniently know what situation causes the restart through the boot event, and therefore reduce the administrator's burden of identifying the boot type and effectively enlarge the server's lifetime.

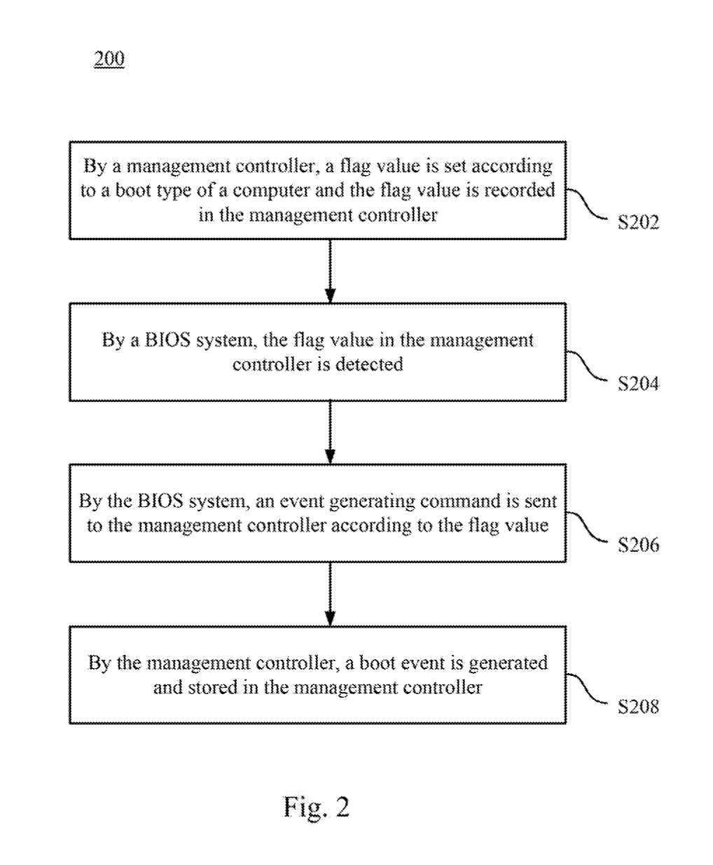

FIGS. 2-5 are flow charts of boot detection methods 200-500 for computer according to an embodiment of the present disclosure. The boot detection methods 200-500 include a plurality of steps S202-S208, S302-S308, S402-S408 and S502-S508 respectively, and can be implemented by the boot detection system 100 for computer as shown in FIG. 1. However, those skilled in the art should understand that, unless a particular sequence is specified, the sequence of the steps in the present embodiment can be adjusted according to actual needs. Moreover, all or some of the steps can even be executed simultaneously. Specific implementation is disclosed as above, and would not be repeated herein.

In step S202, by a management controller, a flag value is set according to a boot type of a computer and the flag value is recorded in the management controller.

In step S204, by a BIOS system, the flag value in the management controller is detected.

In step S206, by the BIOS system, an event generating command is sent to the management controller according to the flag value.

In step S208, by the management controller, a boot event is generated and stored in the management controller.

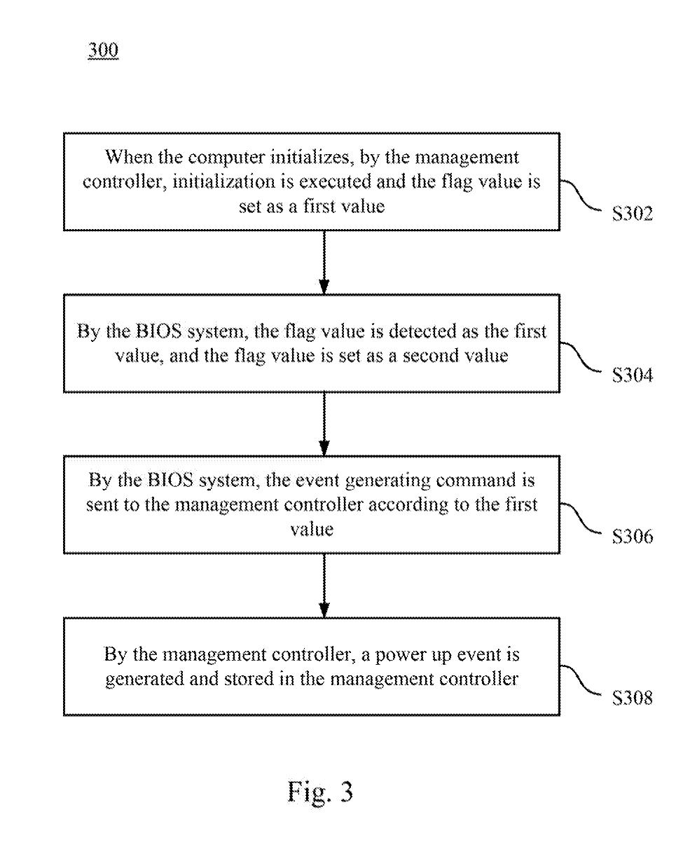

In a specific embodiment, a situation of computer initialization (i.e., an AC power supply in the computer is turned on from an off state) is shown in FIG. 3.

In step S302, when the computer initializes, by the management controller, initialization is executed and the flag value is set as a first value.

In step S304, by the BIOS system, the flag value is detected as the first value, and the flag value is set as a second value.

In step S306, by the BIOS system, the event generating command is sent to the management controller according to the first value.

In step S308, by the management controller, a power up event is generated and stored in the management controller.

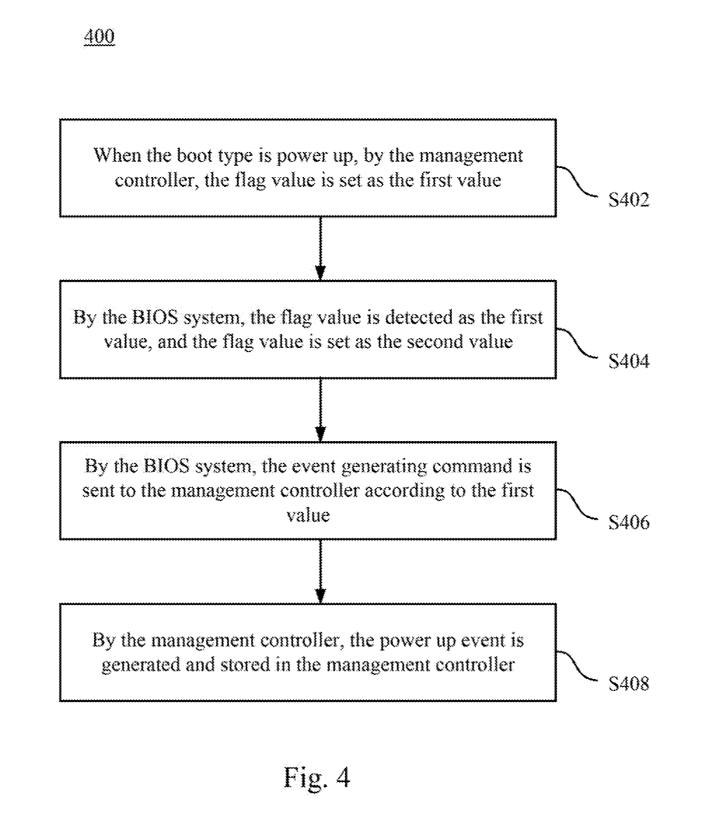

In another specific embodiment, a situation where a DC power supply in the computer is turned off and then turned on is shown in FIG. 4.

In step S402, when the boot type is power up, by the management controller, the flag value is set as the first value.

In step S404, by the BIOS system, the flag value is detected as the first value, and the flag value is set as the second value.

In step S406, by the BIOS system, the event generating command is sent to the management controller according to the first value.

In step S408, by the management controller, the power up event is generated and stored in the management controller.

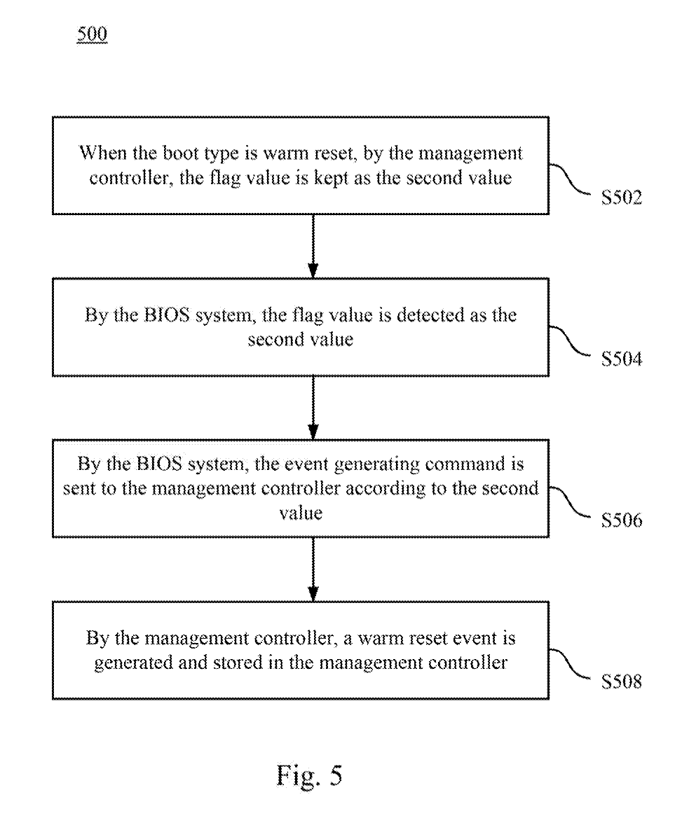

In another specific embodiment, a situation where the DC power supply in the computer keeps on is shown in FIG. 5.

In step S502, when the boot type is warm reset, by the management controller, the flag value is kept as the second value.

In step S504, by the BIOS system, the flag value is detected as the second value.

In step S506, by the BIOS system, the event generating command is sent to the management controller according to the second value.

In step 3508, by the management controller, a warm reset event is generated and stored in the management controller.

Through the above embodiments, the present disclosure can identify whether the boot type of the computer is power up or warm reset by the boot event, that is, whether the DC power supply of the computer is turned off (e.g., power failure) and then turned on. Compared to the prior art that can merely identify whether the computer restarts, the present disclosure can further identify whether the boot type of the computer is power up or warm reset to provide more detailed information to the user, and resolve the problem of incapability of precisely determining the boot type in a recent Internet of things (IoT) system so as to help the administrator and the user to understand machine condition at any time.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A boot detection system for computer, comprising:
a management controller, configured to set a flag value according to a boot type of the computer and record the flag value in the management controller; and
a basic input/output system (BIOS), electrically coupled to the management controller and configured to detect the flag value in the management controller, send an event generating command to the management controller according to the flag value to control the management controller to generate a boot event, and store the boot event in the management controller, wherein the boot event is a power up event or a warm reset event.

2. The boot detection system of claim 1, wherein when the computer is initialized, the management controller initializes and set the flag value as a first value, and the boot event is the power up event.

3. The boot detection system of claim 1, wherein when the boot type is power up, the management controller set the flag value as a first value, and the boot event is the power up event.

4. The boot detection system of claim 1, wherein after the BIOS sets the flag value as a second value after detecting that the flag value is a first value.

5. The boot detection system of claim 4, wherein when the boot type is warn up, the management controller keeps the flag value as the second value, and the boot event is the warm reset event.

6. A boot detection method for computer, comprising:
by a management controller, setting a flag value according to a boot type of the computer and recording the flag value in the management controller;
by a BIOS, detecting the flag value in the management controller;
by the BIOS, sending an event generating command to the management controller according to the flag value; and
by the management controller, generating a boot event and storing the boot event in the management controller, wherein the boot event is a power up event or a warm reset event.

7. The boot detection method of claim 6, further comprising:
when the computer is initialized, by the management controller, initializing and setting the flag value as a first value, wherein the boot event is the power up event.

8. The boot detection method of claim 6, further comprising:
when the boot type is power up, by the management controller, setting the flag value as a first value, wherein the boot event is the power up event.

9. The boot detection method of claim 6, further comprising:
by the BIOS, setting the flag value as a second value after detecting that the flag value is a first value.

10. The boot detection method of claim 9, further comprising:
when the boot type is warm reset, by the management controller, keeping the flag value as the second value, wherein the boot event is the warm reset event.
